(19) United States
(12) Patent Application Publication
(10) Pub. No.: US 2011/0137595 A1
(43) Pub. Date: Jun. 9, 2011

(54) YIELD LOSS PREDICTION METHOD AND ASSOCIATED COMPUTER READABLE MEDIUM

(76) Inventors: Yij-Chieh Chu, Taipei County (TW); Yun-Zong Tian, Taichung County (TW); Shih-Chang Kao, Kaohsiung City (TW); Wei-Jun Chen, Taichung County (TW); Cheng-Hao Chen, Taipei City (TW)

(21) Appl. No.: 12/725,451

(22) Filed: Mar. 16, 2010

(30) Foreign Application Priority Data
Dec. 4, 2009 (TW) 098141503

(51) Int. Cl. G06F 19/00

(52) U.S. Cl. 702/81

(57) ABSTRACT

A yield loss prediction method includes: performing a plurality of types of defect inspections upon a plurality of batches of wafers which begin to be processed during different periods to generate defect inspection data, respectively; for a specific batch of wafers different from the plurality of batches of wafers, calculating defect prediction data of at least one type of defect inspection according to the defect inspection data of at least the type of defect inspections; and predicting a yield loss of the specific batch of wafers according to at least the defect prediction data.

### BACKGROUND OF THE INVENTION

1. Field of the Invention

The present invention relates to a yield loss prediction method, and more particularly, to a yield loss prediction method which utilizes defect prediction data to calculate the yield loss.

2. Description of the Prior Art

In semiconductor processes, a plurality of types of defect inspection are performed upon each batch of wafers to determine which wafer has defects. Then, after the batch of wafers has had all of the defect inspections performed, a yield or a yield loss of the batch of wafers is calculated according to the defect inspection results, or the defect inspection results can be used to determine issues during the semiconductor process, particularly, what needs to be improved. Please refer to FIG. 1. FIG. 1 is a diagram illustrating performing defect inspections upon a plurality of batches of wafers. Referring to the table shown in FIG. 1, assuming that it is the 19^{th} week now, wafers which began to be processed during the 15^{th} week have had all of the defect inspections performed (the 2^{nd} column shown in FIG. 1 are defect inspection values of the defect inspection items DI1-DI8 of the wafers which began to be processed during the 15^{th} week), wafers which began to be processed during the 16^{th} week have only had part of the defect inspections performed (the 3^{rd} column shown in FIG. 1 are defect inspection values of the defect inspection items DI1-DI6 of the wafers which began to be processed during the 16^{th} week), and wafers which began to be processed during the 17^{th} week have only had part of the defect inspections performed (the 4^{th} column shown in FIG. 1 are defect inspection values of the defect inspection items DI1-DI5 of the wafers which began to be processed during the 17^{th} week), . . . and so on. Referring to FIG. 1, because only the wafers which began to be processed during the 15^{th} week have had all of the defect inspections performed, the engineer can only calculate the yield or the yield loss of the wafers which began to be processed during the 15^{th} week, and the engineer cannot calculate the yield or the yield loss of the wafers which began to be processed during the 16^{th}-19^{th} weeks to determine what needs to be improved. That is, the engineer cannot understand or predict the issues which may occur during the semiconductor process from this point on, and is therefore unable to prevent the issues which may occur in the future.

### SUMMARY OF THE INVENTION

It is therefore an objective of the present invention to provide a yield loss prediction method and associated computer readable medium, which is able to calculate defect prediction data according to the known defect inspection data, and predict the yield loss according to the defect prediction data to make the engineer know the issues which may occur during the semiconductor process from the present time on, to solve the above-mentioned problems.

According to one embodiment of the present invention, a yield loss prediction method comprises: performing a plurality of types of defect inspections upon a plurality of batches of wafers which began to be processed during different periods to generate defect inspection data, respectively; for a specific batch of wafers different from the plurality of batches of wafers, calculating defect prediction data of at least one type of defect inspection according to the defect inspection data of at least the type of defect inspections; and predicting a yield loss of the specific batch of wafers according to at least the defect prediction data.

According to another embodiment of the present invention, a yield loss prediction method comprises: performing a plurality of types of defect inspections upon a batch of wafers to generate defect inspection data, respectively; for another batch of wafers, calculating defect prediction data of at least one type of defect inspection according to the defect inspection data of at least the type of defect inspections; and predicting a yield loss of the other batch of wafers according to at least the defect prediction data.

According to another embodiment of the present invention, a computer readable medium storing a program code which is utilized for estimating a yield loss is disclosed. When the program code is executed by a processor, the program code executes the following steps: receiving defect inspection data which is obtained by performing a plurality of types of defect inspections upon a plurality of batches of wafers which began to be processed during different periods; for a specific batch of wafers different from the plurality of batches of wafers, calculating defect prediction data of at least one type of defect inspection according to the defect inspection data of at least the type of defect inspections; and predicting a yield loss of the specific batch of wafers according to at least the defect prediction data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating performing defect inspections upon a plurality of batches of wafers.

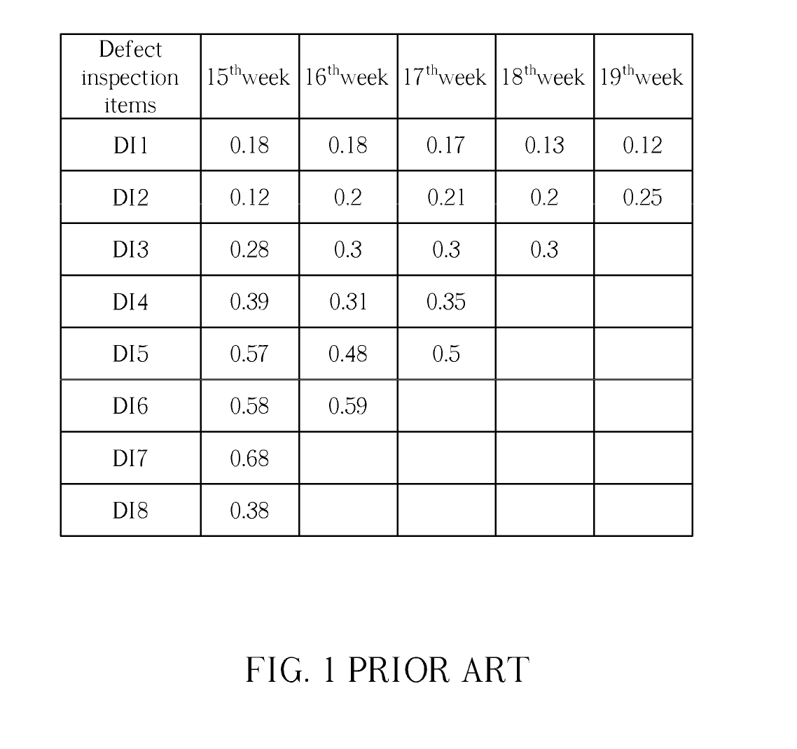

FIG. 2 is a flowchart of a yield loss prediction method according to one embodiment of the present invention.

FIG. 3 is a diagram illustrating performing defect inspections upon a plurality of batches of wafers.

FIG. 4 is a diagram illustrating using the defect inspection data of the defect inspection DI8 performed on the wafers which began to be processed during the 11^{th}-15^{th} weeks to calculate the defect prediction data P_{W16}_{_{—}}₈ of the defect inspection DI8 of the wafers which began to be processed during the 16^{th} week.

FIG. 5 is a diagram illustrating a confidence interval of the yield loss.

FIG. 6 is a diagram illustrating a computer readable medium according to one embodiment of the present invention.

### DETAILED DESCRIPTION

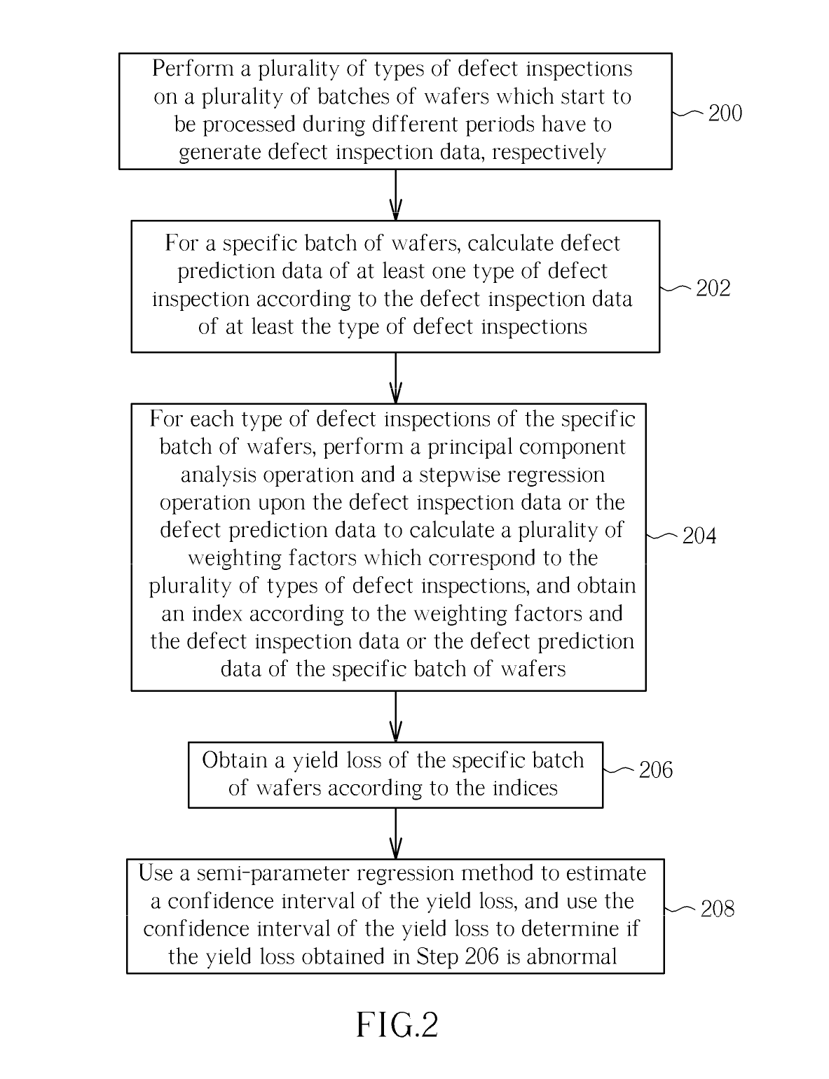

Please refer to FIG. 2. FIG. 2 is a flowchart of a yield loss prediction method according to one embodiment of the present invention. Referring to FIG. 2, the flow of the yield loss prediction method is described as follows:

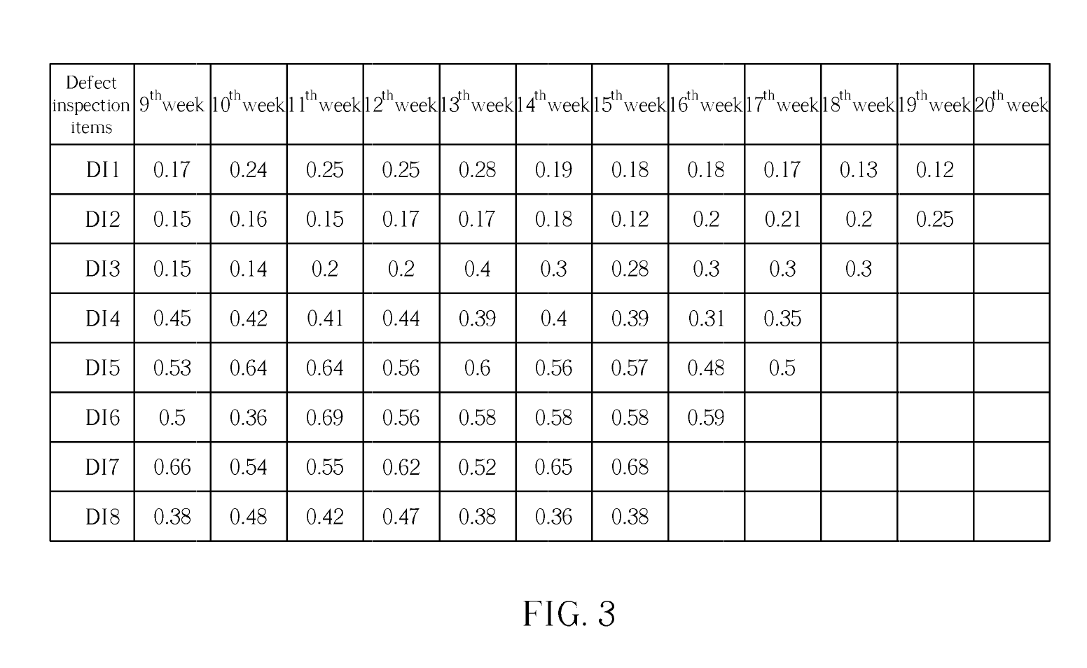

In Step 200, a plurality of batches of wafers which begin to be processed during different periods have a plurality of types of defect inspections performed on them to generate defect inspection data, respectively. A table shown in FIG. 3 is taken as an example. FIG. 3 is a diagram illustrating performing defect inspections upon a plurality of batches of wafers. Assume that the wafers need to have eight types of defect inspections DI1-DI8 performed, that the values shown in the tables (i.e., defect inspection data) correspond to defect counts of the wafers (i.e., the values shown in the tables are results of performing a predetermined operation upon the defect counts of the wafers), and as shown in FIG. 3, the wafers which began to be processed during the 9^{th}-15^{th} weeks have had all types of defect inspections performed, and the wafers which began to be processed during the 16^{th}-19^{th} weeks have only had part of the defect inspections performed. It is noted that the tables shown in FIG. 3 are for illustrative purposes only. In other embodiments of the present invention, more than eight types of defect inspections can be performed upon the wafers, and the wafers do not need to be classified according to the unit “week”. In addition, the wafers which have had all types of defect inspections performed can be one batch or more batches of wafers (a batch of wafers means that the wafers began to be processed during the same week).

In Step 202, for a specific batch of wafers, defect prediction data of at least one type of defect inspection is calculated according to the defect inspection data of at least the type of defect inspections. For example, assuming that the wafers which began to be processed during the 16^{th} week serve as the specific batch of wafers, the defect inspection data of the defect inspection DI7 performed on the wafers which began to be processed during the 11^{th}-15^{th} weeks can be used to calculate the defect prediction data of the defect inspection DI7 of the wafers which began to be processed during the 16^{th} week. Similarly, the defect inspection data of the defect inspection DI8 performed on the wafers which began to be processed during the 11^{th}-15^{th} weeks can be used to calculate the defect prediction data of the defect inspection DI8 of the wafers which began to be processed during the 16^{th} week.

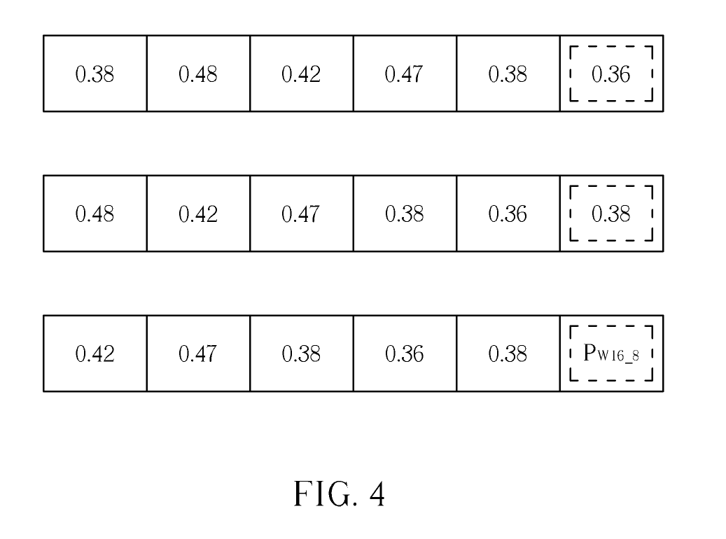

Many methods can be used for calculating the defect prediction data of the defect inspections DI7 and DI8 of the wafers which began to be processed during the 16^{th} week. An example is shown in FIG. 4. FIG. 4 is a diagram illustrating using the defect inspection data of the defect inspection DI8 performed on the wafers which began to be processed during the 11^{th}-15^{th} weeks to calculate the defect prediction data P_{W16}_{_{—}}₈ of the defect inspection DI8 of the wafers which began to be processed during the 16^{th} week. As shown in FIG. 4, the first row shows the defect inspection data of the defect inspection DI8 performed on the wafers which began to be processed during the 9^{th}-14^{th} weeks, the second row shows the defect inspection data of the defect inspection DI8 performed on the wafers which began to be processed during the 10^{th}-15^{th} weeks, and the third row shows the defect inspection data of the defect inspection DI8 performed on the wafers which began to be processed during the 11^{th}-15^{th} weeks. Then, by referring to a relationship between the defect inspection data (0.36) performed on the wafers which began to be processed during the 14^{th} week and the defect inspection data (0.38, 0.48, 0.42, 0.47 and 0.38) performed on the wafers which began to be processed during the 9^{th}-13^{th} weeks, and further by referring to a relationship between the defect inspection data (0.38) performed on the wafers which began to be processed during the 15^{th} week and the defect inspection data (0.48, 0.42, 0.47, 0.38 and 0.36) performed on the wafers which began to be processed during the 10^{th}-14^{th} weeks, the defect prediction data P_{W16}_{_{—}}₈ of the wafers which began to be processed during the 6^{th} weeks can be calculated according to the defect inspection data (0.42, 0.47, 0.38, 0.36 and 0.38) performed on the wafers which began to be processed during the 11^{th}-15^{th} weeks.

Then, in Step 204, for each type of defect inspections of the specific batch of wafers, the defect inspection data or the defect prediction data are under a principal component analysis (PCA) operation and a stepwise regression operation to calculate a plurality of weighting factors which correspond to the plurality of types of defect inspections, and an index is obtained according to the weighting factors and the defect inspection data or the defect prediction data of the specific batch of wafers. Taking the data shown in FIG. 3, assuming the wafers which began to be processed during the 16^{th} week serve as the specific batch of wafers, the index Y_{8*1} can be calculated as follows:

Y_{8*1}=D_{8*8}A_{8*3}B_{3*1}

where D_{8*8} is the defect inspection data or the calculated defect prediction data of the wafers which began to be processed during the 9^{th}-16^{th} weeks, that is:

$${D}_{8 * 8} = [ \begin{matrix}0.17 & 0.24 & 0.25 & 0.25 & 0.28 & 0.19 & 0.18 & 0.18 \\ 0.15 & 0.16 & 0.15 & 0.17 & 0.17 & 0.18 & 0.2 & 0.2 \\ 0.15 & 0.14 & 0.2 & 0.2 & 0.4 & 0.3 & 0.28 & 0.3 \\ 0.45 & 0.42 & 0.41 & 0.44 & 0.39 & 0.4 & 0.39 & 0.31 \\ 0.53 & 0.64 & 0.64 & 0.56 & 0.6 & 0.56 & 0.57 & 0.48 \\ 0.5 & 0.36 & 0.69 & 0.56 & 0.58 & 0.58 & 0.58 & 0.59 \\ 0.66 & 0.54 & 0.55 & 0.62 & 0.52 & 0.65 & 0.68 & {P}_{W 16 \_ 7} \\ 0.38 & 0.48 & 0.42 & 0.47 & 0.38 & 0.38 & 0.38 & {P}_{W 16 \_ 8}\end{matrix} ]$$

The matrices A_{8*3} and B_{3*1} are for the principal component analysis operation and the stepwise regression operation, respectively, where the principal component analysis operation is for transforming a number of possibly correlated defect inspection data into a smaller number of uncorrelated variables called principal components, and the stepwise regression operation is for selecting part of the principal components which are more explanatory to the yield loss (in this embodiment, three principal components are selected from eight principal components). In detail, A_{8*3}B_{3*1} are weighting factors corresponding to the defect inspection items, and the 8^{th} element of the index Y₈₍₁ is an index corresponding to the wafers which began to be processed during the 16^{th} week. In other words, the weighting factors of the plurality of defect inspection items of the wafers which began to be processed during the 16^{th} week can be calculated according to the above-mentioned principal component analysis operation and the stepwise regression operation, and these weighting factors represent the degrees to which the defect inspection items influence the yield loss. In addition, because a person skilled in this art should understand the operations of the principal component analysis and the stepwise regression, further descriptions are omitted here.

In Step 206, the yield loss of the specific batch of wafers is obtained according to the indices. In other words, for the wafers which began to be processed during the 16^{th} week, the indices calculated in Step 204 are used with a predetermined model to calculate the yield loss of the wafers which began to be processed during the 16^{th} week.

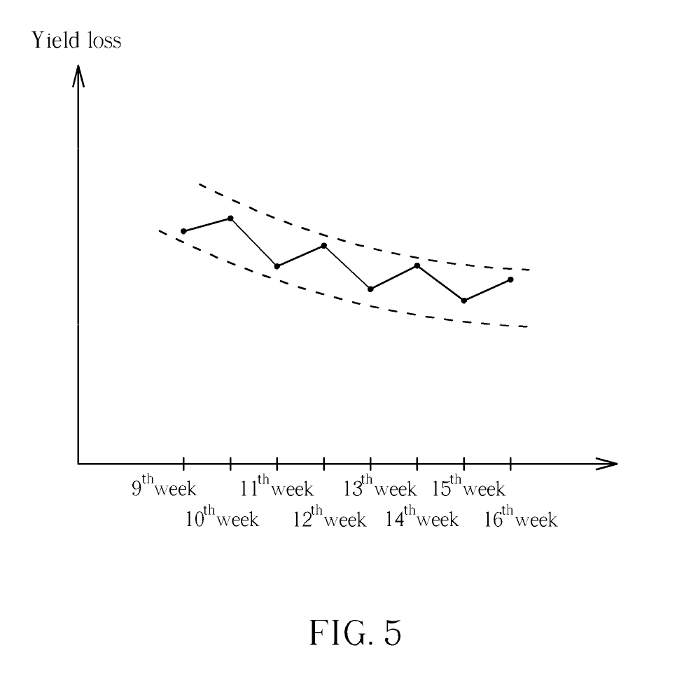

In Step 208, a semi-parameter regression method is used for estimating a confidence interval of the yield loss (e.g., the region between two dotted lines shown in FIG. 5), and the confidence interval of the yield loss is used for determining if the yield loss obtained in Step 206 is abnormal.

It is noted that only the wafers which began to be processed during the 16^{th} week are taken as an example above; however, after reading the above-mentioned descriptions, a person skilled in this art should understand how to fill the table shown in FIG. 3 with the defect prediction data, and obtain an estimated yield loss of each batch of wafers. Particularly, referring to FIG. 2, although none of the defect inspection items is performed on the wafers which began to be processed during the 20^{th} week, the defect prediction data of the defect inspection items DI1-DI8 of the wafers which began to be processed during the 20^{th} week can be calculated according to the above-mentioned calculating steps, and the estimated yield loss of the wafers which began to be processed during the 20^{th} week can be calculated according to the defect prediction data of the defect inspection items DI1-DI8.

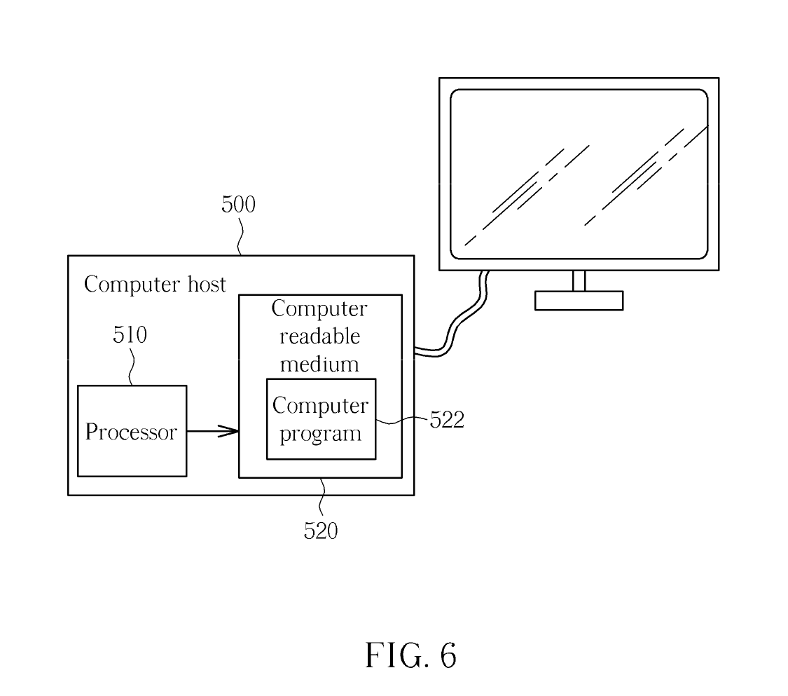

In addition, the Steps shown in FIG. 2 can be executed by a computer program stored in a computer readable medium. In detail, please refer to FIG. 6, a computer host 500 comprises at least one processor 510 and a computer readable medium 520, where the computer readable medium 520 can be a hard disk or any other storage device, and the computer readable medium 520 stores a computer program 522. When the processor 510 executes the computer program 522, the computer host 500 will execute the steps shown in FIG. 2.

Briefly summarized, in the yield loss prediction method of the present invention, defect inspection data of a plurality of batches of wafers are used to calculate defect prediction data of a next batch of wafers, and a yield loss of the next batch of wafers is calculated according to the defect prediction data. Therefore, the engineer can predict the issues which may occur during the semiconductor process from this point on, and can also do something to prevent these issues which may occur in the future.

Those skilled in the art will readily observe that numerous modifications and alterations of the device and method may be made while retaining the teachings of the invention.

What is claimed is:

1. A yield loss prediction method, comprising:
performing a plurality of types of defect inspections upon a plurality of batches of wafers which begin to be processed during different periods to generate defect inspection data, respectively;
for a specific batch of wafers different from the plurality of batches of wafers, calculating defect prediction data of at least one type of defect inspection according to the defect inspection data of at least the type of defect inspections; and
predicting a yield loss of the specific batch of wafers according to at least the defect prediction data.

2. The yield loss prediction method of claim 1, wherein a timing of the specific batch of wafers which begin to be processed is later than a timing of the plurality of batches of wafers which begin to be processed.

3. The yield loss prediction method of claim 1, further comprising:
performing part of the types of defect inspections upon the specific batch of wafers to generate at least one defect inspection data of the part of the types of defect inspections;
wherein the step of predicting the yield loss of the specific batch of wafers according to at least the defect prediction data comprises:
predicting the yield loss of the specific batch of wafers according to at least the defect prediction data and at least the defect inspection data of the part of the types of defect inspections.

4. The yield loss prediction method of claim 3, wherein the step of predicting the yield loss of the specific batch of wafers according to at least the defect prediction data and at least the defect inspection data of the part of the types of defect inspections comprises:
calculating a plurality of weighting factors which correspond to the plurality of types of defect inspections, respectively, according to the defect inspection data or the defect prediction data of the plurality of types of defect inspections performed upon the specific batch of wafers;
obtaining an index by performing a weighted algorithm upon the defect inspection data or the defect prediction data of the plurality of types of defect inspection performed upon the specific batch of wafers according to the plurality of weighting factors; and
obtaining the yield loss of the specific batch of wafers according to the index.

5. The yield loss prediction method of claim 4, wherein the step of calculating the plurality of weighting factors which correspond to the plurality of types of defect inspections, respectively, comprises:
performing a principal component analysis operation and a stepwise regression operation upon the defect inspection data or the defect prediction data of the plurality of types of defect inspections performed upon the specific batch of wafers, to generate the plurality of weighting factors which correspond to the plurality of types of defect inspections.

6. The yield loss prediction method of claim 1, wherein the step of calculating the defect prediction data of at least the type of defect inspection according to the defect inspection data of at least the type of defect inspections comprises:
for the specific batch of wafers, calculating a plurality of defect prediction data of the plurality of types of defect inspections, respectively, according to the defect inspection data of at least the type of defect inspections; and
the step of predicting the yield loss of the specific batch of wafers according to at least the defect prediction data comprises:
predicting the yield loss of the specific batch of wafers according to the plurality of defect prediction data.

7. The yield loss prediction method of claim 6, wherein the step of predicting the yield loss of the specific batch of wafers according to the plurality of defect prediction data comprises:
calculating a plurality of weighting factors which correspond to the plurality of types of defect inspections, respectively, according to the plurality of defect prediction data;
obtaining an index by performing a weighted algorithm upon the defect prediction data according to the plurality of weighting factors; and
obtaining the yield loss of the specific batch of wafers according to the index.

8. The yield loss prediction method of claim 7, wherein the step of calculating the plurality of weighting factors which correspond to the plurality of types of defect inspections comprises:
performing a principal component analysis operation and a stepwise regression operation upon the plurality of defect prediction data to generate the plurality of weighting factors which correspond to the plurality of types of defect inspections.

9. A yield loss prediction method, comprising:
performing a plurality of types of defect inspections upon a batch of wafers to generate a plurality of defect inspection data, respectively;
for another batch of wafers, calculating defect prediction data of at least one type of defect inspection according to the defect inspection data of at least the type of defect inspections; and
predicting a yield loss of the other batch of wafers according to at least the defect prediction data.

10. A computer readable medium storing a program code which is utilized for estimating a yield loss, where when the program code is executed by a processor, the program code executes the following steps:
performing a plurality of types of defect inspections upon a plurality of batches of wafers which begin to be processed during different periods to generate defect inspection data, respectively;
for a specific batch of wafers different from the plurality of batches of wafers, calculating defect prediction data of at least one type of defect inspection according to the defect inspection data of at least the type of defect inspections; and
predicting a yield loss of the specific batch of wafers according to at least the defect prediction data.

11. The computer readable medium of claim 10, wherein when the program code is executed by the processor, the program code further executes the following steps:
performing part of the types of defect inspections upon the specific batch of wafers to generate at least one defect inspection data of the part of the types of defect inspections;
predicting the yield loss of the specific batch of wafers according to at least the defect prediction data and at least the defect inspection data of the part of the types of defect inspections.

12. The computer readable medium of claim 11, wherein the program code calculates a plurality of weighting factors which correspond to the plurality of types of defect inspections, respectively, according to the defect inspection data or the defect prediction data of the plurality of types of defect inspections performed upon the specific batch of wafers; the program code obtains an index by performing a weighted algorithm upon the defect inspection data or the defect prediction data of the plurality of types of defect inspection performed upon the specific batch of wafers according to the plurality of weighting factors; and the program code further obtains the yield loss of the specific batch of wafers according to the index.

13. The computer readable medium of claim 12, wherein the program code performs a principal component analysis operation and a stepwise regression operation upon the defect inspection data or the defect prediction data of the plurality of types of defect inspections performed upon the specific batch of wafers, to generate the plurality of weighting factors which correspond to the plurality of types of defect inspections.

14. The computer readable medium of claim 10, wherein for the specific batch of wafers, the program code calculates a plurality of defect prediction data of the plurality of types of defect inspections, respectively, according to the defect inspection data of at least the type of defect inspections; and the program code predicts the yield loss of the specific batch of wafers according to the plurality of defect prediction data.

15. The computer readable medium of claim 14, wherein the program code calculates a plurality of weighting factors which correspond to the plurality of types of defect inspections, respectively, according to the plurality of defect prediction data; the program code obtains an index by performing a weighted algorithm upon the defect prediction data according to the plurality of weighting factors; and the program code further obtains the yield loss of the specific batch of wafers according to the index.

16. The computer readable medium of claim 15, wherein the program code performs a principal component analysis operation and a stepwise regression operation upon the plurality of defect prediction data to generate the plurality of weighting factors which correspond to the plurality of types of defect inspections.
